(19) United States
(12) Patent Application Publication
(10) Pub. No.: US 2018/0111158 A1
(43) Pub. Date: Apr. 26, 2018

(54) METHOD OF MANUFACTURING COMPOSITE FILM

(71) Applicant: TEIJIN LIMITED, Osaka (JP)

(72) Inventors: Noboru TANIKAWA, Osaka-shi (JP); Hiroyuki HONMOTO, Osaka-shi (JP)

(73) Assignee: TEIJIN LIMITED, Osaka-shi, Osaka (JP)

(21) Appl. No.: 15/560,838

(22) PCT Filed: Dec. 10, 2015
(86) PCT No.: PCT/JP2015/084722

§ 371 Date: Sep. 22, 2017

(30) Foreign Application Priority Data
Mar. 27, 2015 (JP) 2015-067607

(51) Int. Cl. B05D 3/02; H01M 2/14; H01M 2/16; C09D 177/10; C08J 7/04; F26B 13/18; F26B 13/08

(52) U.S. Cl. CPC B05D 3/0254; H01M 2/145; H01M 2/1686; H01M 2/166; C08J 2477/10; C08J 7/047; F26B 13/18; F26B 13/08; C08J 2323/06; C09D 177/10

(57) ABSTRACT

A method of manufacturing a composite film, the method including: a coating step including coating a coating liquid containing a resin on one surface or both surfaces of a porous substrate to form a coating layer; a solidification step including solidifying the resin by bringing the coating layer into contact with a solidifying liquid to obtain a composite film including the porous substrate and a porous layer that is formed on one surface or both surfaces of the porous substrate and that includes the resin; a water washing step including washing the composite film with water; and a drying step including drying by removing water from the composite film while transporting the composite film at a transport speed of 30 m/min or more using a drying apparatus including a drying device including a contact type heating device and a hot air blowing device, wherein the composite film is brought into contact with a contact type heating device as well as exposed to hot air blown from a hot air blowing device, to remove water from the composite film being performed by bringing.

### TECHNICAL FIELD

The present disclosure relates to a method of manufacturing a composite film.

### BACKGROUND ART

Composite films including a porous substrate and a porous layer provided on the porous substrate are conventionally known as battery separators, gas filters, liquid filters, and the like. As a method of manufacturing the composite film described above, a method, that is called as a wet process, is known in which a coating liquid containing a resin is coated on a porous substrate to form a coating layer; solidifying the resin contained in the coating layer by immersing the resultant to a solidifying liquid; and forming a porous layer via water washing and drying (see Patent Document 1, for example). The wet process has been known as a method which enables to favorably porosify a porous layer containing a resin.

### RELATED ART DOCUMENT

### Patent Document

Patent Document 1: JP 5134526 B

### SUMMARY OF INVENTION

### Technical Problem

In order to mass-produce a composite film including a porous substrate and a porous layer provided on the porous substrate by the wet process manufacturing method, it is preferable to transport a porous substrate having a long length to be subjected to respective steps of coating, solidification, water-washing, and drying in sequence, and to carry out these steps continuously. At this time, the porous substrate is preferably transported at an increased transport speed in the respective steps, in terms of improving productivity. However, when the drying step is carried out while transporting the porous substrate at an increased transport speed, there may be a case in which a porous layer provided on the porous substrate peels off and/or shrinkage, deformation, or wrinkles may occur in the composite film. So far, there has not yet been proposed a suitable means to solve the above mentioned problem in the drying step of the wet process manufacturing method.

The embodiment according to the invention has been done in view of the above described problems.

An object of the embodiment according to the invention is to provide a method of manufacturing a composite film, which method is capable of manufacturing a composite film having a high quality at a high production efficiency.

Specific means to solve the above-described problem include the followings.

[1] A method of manufacturing a composite film, the method comprising:

a coating step comprising coating a coating liquid containing a resin on one surface or both surfaces of a porous substrate to form a coating layer;

a solidification step comprising solidifying the resin by bringing the coating layer into contact with a solidifying liquid to obtain a composite film comprising the porous substrate and a porous layer that is formed on one surface or both surfaces of the porous substrate and that comprises the resin;

a water washing step comprising washing the composite film with water; and

a drying step comprising drying by removing water from the composite film while transporting the composite film at a transport speed of 30 m/min or more using a drying apparatus comprising a drying device including a contact type heating device and a hot air blowing device, wherein the composite film is brought into contact with a contact type heating device as well as exposed to hot air blown from a hot air blowing device, to remove water from the composite film being performed by bringing.

[2] The method of manufacturing a composite film according to [1], wherein the porous substrate would exhibit a heat shrinkage ratio in a machine direction of 10% or less and a heat shrinkage ratio in a width direction of 5% or less, when the porous substrate has been left to stand at a temperature of 105° C. for 30 minutes.

[3] The method of manufacturing a composite film according to [1] or [2],

wherein a surface of the contact type heating device which comes into contact with the composite film has a temperature of 105° C. or lower, and

wherein the hot air has a temperature of 105° C. or lower at an air blowing port of the hot air blowing device.

[4] The method of manufacturing a composite film according to any one of [1] to [3], wherein the hot air has a wind velocity of from 5 m/sec to 30 m/sec at an air blowing port of the hot air blowing device.

[5] The method of manufacturing a composite film according to any one of [1] to [4],

wherein the drying apparatus comprises two or more of the drying device;

wherein two or more contact type heating devices included in the drying apparatus are divided into two or more groups based on whether temperatures of surfaces of the contact type heating devices that come into contact with the composite film are the same as or different from each other, the two or more groups including a first group located at most upstream in a transport direction of the composite film and a second group located directly downstream of the first group; and

wherein the temperature of the surface of each of the contact type heating devices forming the second group is higher than the temperature of the surface of each of the contact type heating devices forming the first group.

[6] The method of manufacturing a composite film according to any one of [1] to [5], wherein a total contact length of the contact type heating device(s) with the composite film is 30 m or less.

[7] The method of manufacturing a composite film according to any one of [1] to [6], wherein the drying apparatus comprises a housing having an inlet and an outlet and the drying device is disposed in the housing, and wherein a length of transportation of the composite film from the receiving inlet to the outlet is 50 m or less.

[8] The method of manufacturing a composite film according to any one of [1] to [7], wherein a surface of the contact type heating device which come into contact with the composite film contains a fluororesin.

### Effects of Invention

According to an embodiment of the invention, a method of manufacturing a composite film, which is capable of manufacturing a composite film having a high quality at a high production efficiency, is provided.

### BRIEF DESCRIPTION OF DRAWINGS

FIG. 1 is a schematic diagram illustrating one embodiment of the method of manufacturing of the present disclosure.

FIG. 2 is a schematic view illustrating one example of a drying device used in the method of manufacturing of the present disclosure.

FIG. 3A is a perspective view showing an example of an air blowing port of a hot air blowing device.

FIG. 3B is a perspective view showing an example of an air blowing port of a hot air blowing device.

### DESCRIPTION OF EMBODIMENTS

The value range shown using the expression “from . . . to . . . ” in this specification is a range including values described before and after the term “to” as a minimum value and a maximum value, respectively.

In this specification, the term “step” refers not only to an independent step, but also to a step that cannot be clearly distinguished from other steps as long as an expected action of the step is achieved.

In this specification, the “machine direction” means a long direction of a long separator, and the “transverse direction” means a direction orthogonal to the longitudinal direction of the separator. The “machine direction” is also referred to as a “MD direction”, and the “transverse direction” is also referred to as a “TD direction”.

Hereinafter, an embodiment of the invention will be described. The descriptions and examples are intended to illustrate the invention, and are not intended to limit the scope of the invention.

<Method of Manufacturing Composite Film>

The method of manufacturing a composite film according to the present disclosure is a method of manufacturing a composite film including: a porous substrate; and a porous layer formed on one surface or both surfaces of the porous substrate, and containing a resin. The manufacturing method according to the present disclosure is a method in which a coating liquid containing a resin is coated on one surface or both surfaces of a porous substrate, to form a porous layer on one surface or both surfaces of the porous substrate. The manufacturing method according to the present disclosure includes the following steps.
Coating step: a step of coating the coating liquid containing a resin on one surface or both surfaces of a porous substrate, to form a coating layer.
Solidification step: a step of solidifying the resin contained in the coating layer by contacting the coating layer to a solidifying liquid, to obtain a composite film including the porous substrate and a porous layer formed on one surface or both surfaces of the porous substrate, and containing the resin.
Water washing step: a step of washing the composite film with water by transporting the composite film in a water washing tank.
Drying step: a step of removing water from the composite film.

The manufacturing method according to the present disclosure is a method which includes providing a porous layer by a process which is so-called a wet process.

The manufacturing method according to the present disclosure may further include a coating liquid preparation step of preparing a coating liquid to be used in the coating step.

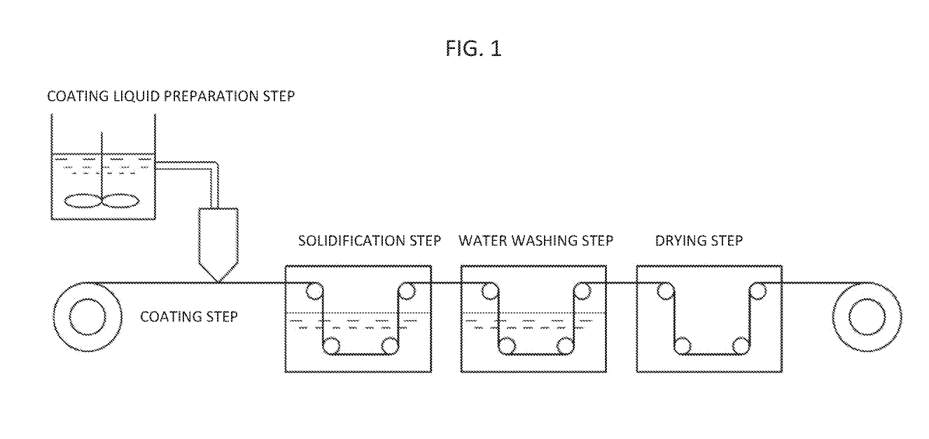

FIG. 1 is a schematic diagram showing one embodiment of the manufacturing method according to the present disclosure. In FIG. 1, a roll of the porous substrate to be used in the production of the composite film is shown on the left side in the figure, and a roll around which the resulting composite film is wound is shown on the right side in the figure. The embodiment shown in FIG. 1 includes the coating liquid preparation step, the coating step, solidification step, the water washing step, and the drying step. In the present embodiment, the coating step, the solidification step, the water washing step, and the drying step are carried out continuously and sequentially. Further, in the present embodiment, the coating liquid preparation step is carried out at time points suitable for carrying out the coating step. Details regarding the respective steps will be described later.

In the manufacturing method according to the present disclosure, the transport speed of the composite film in the drying step is 30 m/min or more, in terms of the production efficiency of the composite film. As the transport speed is increased, it becomes more difficult to remove water adhered to the composite film. Therefore, it is important how the composite film can be sufficiently dried while maintaining a high quality of the film. In view of the above, the drying step in the manufacturing method according to the present disclosure is a step in which a drying device including a contact type heating device and a hot air blowing device is used, and in which the composite film is brought into contact with the contact type heating device, in addition that the composite film is exposed to hot air blown from the hot air blowing device, thereby removing water from the composite film. This drying step is less likely to cause peeling of the porous layer, as compared to the drying step in which only a contact type heating device is used as the drying device, and is less likely to cause shrinkage, deformation, and/or wrinkles to occur in the composite film, as compared the drying step in which only a hot air blowing device is used as the drying device. Thus, the manufacturing method according to the present disclosure enables to manufacture a composite film having a high quality at a high production efficiency. When the transport speed of the composite film in the drying step is less than 30 m/min, the production efficiency may be reduced, and there is a case in which shrinkage, deformation, or wrinkles occurs in the composite film or peeling of the porous layer occurs.

According to the manufacturing method of the present disclosure, the time required for carrying out the drying step can be reduced; an increase in a transport length in the drying step is not required; and an installation space and an installation cost of the production facility can be reduced, since a drying device including a contact type heating device and a hot air blowing device is used in combination, and the removal of water from the composite film is carried out using both the device.

The respective steps in the manufacturing method according to the present disclosure will now be described in detail.

[Coating Liquid Preparation Step]

The manufacturing method of the present disclosure may include a coating liquid preparation step, which is a step for preparing a coating liquid used in the coating step. The manufacturing method of the present disclosure can be a method which does not include the coating liquid preparation step, and a coating liquid which is manufactured in advance and stored can be used in the coating step therefor.

The coating liquid preparation step is a step for preparing a coating liquid containing a resin. The coating liquid is prepared, for example, by dissolving a resin in a solvent, and by further dispersing an inorganic filler or an organic filler in the resultant if necessary. Details regarding the resin, the filler and the like used in the preparation of the coating liquid, namely, the resin and the filler contained in the porous layer, will be described in the section of “Porous Layer” to be described later.

Examples of the solvent to be used for dissolving the resin in the preparation of the coating liquid (hereinafter, also referred to as “good solvent”) include a polar amide solvent such as N-methylpyrrolidone, dimethylacetamide, dimethylformamide, and dimethylformamide. In terms of forming a porous layer having a favorable porous structure, it is preferable to add and mix a phase separating agent for inducing phase separation, in addition to the good solvent. Examples of the phase separating agent include water, methanol, ethanol, propyl alcohol, butyl alcohol, butanediol, ethylene glycol, propylene glycol, and tripropylene glycol. It is preferable that the phase separating agent is added and mixed with the good solvent to the extent that the resulting coating liquid has a viscosity suitable for the coating.

The solvent to be used in the preparation of the coating liquid is preferably a mixed solvent containing 60% by mass or more of the good solvent, and from 5% by mass to 40% by mass of the phase separating agent, in terms of forming a favorable porous structure. It is preferable that the coating liquid contains a resin in a concentration of from 3% by mass to 15% by mass in terms of forming a favorable porous structure.

[Coating Step]

The coating step is a step of coating the coating liquid containing a resin on one surface or both surfaces of a porous substrate, to form a coating layer. The coating of the coating liquid on the porous substrate is carried out by a coating means such as a Meyer bar, a die coater, a reverse roll coater, or a gravure coater. A total amount of the coating liquid to be coated on both surfaces is, for example, from 10 mL/m² to 60 mL/m².

One embodiment of the coating step is an embodiment in which the coating liquid is simultaneously coated on both surfaces of the porous substrate, using a first coating means for coating one surface of the porous substrate, and a second coating means for coating the other surface of the porous substrate, which coating means are disposed so as to face each other with the porous substrate interposed therebetween.

One embodiment of the coating step is an embodiment in which the coating liquid is coated on both surfaces of the porous substrate by coating one surface at a time in sequence, using the first coating means for coating one surface of the porous substrate, and the second coating means for coating the other surface of the porous substrate, which coating means are disposed spaced apart from each other in a transport direction of the porous substrate.

[Solidification Step]

The solidification step is a step in which the coating layer is brought into contact with a solidifying liquid to solidify the resin contained in the coating layer, thereby obtaining a composite film having a porous layer on one surface or both surfaces of a porous substrate. The contacting of the coating layer to a solidifying liquid is preferably performed by making the coating layer pass through a tank containing a solidifying liquid (solidification tank).

The solidifying liquid is generally a mixture of a good solvent and a phase separating agent used in the preparation of the coating liquid, and water. A mixing ratio of the good solvent and the phase separating agent is preferably the same as the mixing ratio of the mixed solvent used in the preparation of the coating liquid, in terms of production. A content of water in the solidifying liquid is preferably from 40% by mass to 80% by mass with respect to the total amount of the solidifying liquid, in terms of formability of the porous structure and productivity. The temperature of the solidifying liquid may be, for example, from 10° C. to 50° C.

[Water Washing Step]

The water washing step is a step which is performed by transporting the composite film through a water bath for the purpose of removing solvents contained in the composite film (the solvent used in the coating liquid and the solvent used in the solidifying liquid). The water washing step is preferably a step in which the composite film is transported in a water bath. A temperature of water in the water bath is, for example, from 0° C. to 70° C.

[Drying Step]

The drying step is carried out for the purpose of removing water contained in the composite film which has been washed with water.

The transport speed of the composite film in the drying step is 30 m/min or more, in terms of the production efficiency of the composite film. The transport speed is more preferably 40 m/min or more, and still more preferably 50 m/min or more. At the same time, an upper limit of the transport speed is 100 m/min or less, in terms of securing the time for carrying out drying.

The drying apparatus used for carrying out the drying step includes a drying device including a contact type heating device and a hot air blowing device. The drying apparatus includes one or two or more of the drying device. The drying apparatus preferably includes two or more drying devices, in terms of drying efficiency.

Specifically, the contact type heating device may be, for example, a heating roll, a heating belt, a hot plate, or the like. In a case in which the contact type heating device is a heating roll or a heating belt, an outer circumferential surface of the heating roll or the heating belt is a surface which comes into contact with the composite film.

In the manufacturing method according to the present disclosure, the drying apparatus may or may not include a housing. The drying apparatus preferably includes a housing in terms of controlling the temperature and humidity around the composite film.

Exemplary embodiments of the drying apparatus will now be described with reference to drawings. However, the manufacturing method according to the present disclosure is in no way limited by these examples. A description will be given below regarding the exemplary embodiments of the drying apparatus, taking as an example the case in which heating rolls are used as the contact type heating device. The exemplary embodiments of the drying apparatus described below are also applicable to a drying apparatus including device other than heating rolls (such as heating belts or hot plates) as the contact type heating device. In exemplary embodiments in which the contact type heating device are, for example, heating belts or hot plates, the drying can be carried out by replacing heating rolls 31 to 34 with heating belts 31 to 34 or hot plates 31 to 34.

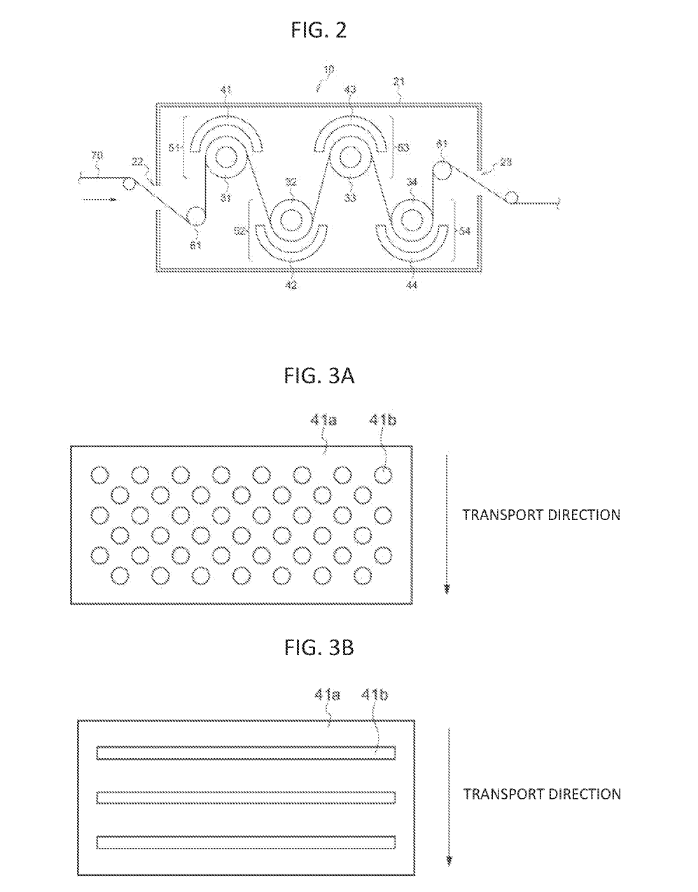

A drying apparatus 10 shown in FIG. 2 includes: a housing 21; drying device 51 to 54 disposed in the interior of the housing 21; and drive rolls 61 for transporting a composite film 70. The housing 21 has an inlet 22 for receiving the composite film 70, and an outlet 23 for discharging the composite film 70. The housing 21 is made of, for example, a metal. Rotational velocities of the drive rolls 61 are controlled by a motor and a control section, which are not shown in the figure.

The drying apparatus 10 may further include a temperature sensor, a humidity sensor, and an exhaust duct, for the purpose of controlling the temperature and humidity inside the housing 21.

In the drying apparatus 10, the length of transportation of the composite film 70 from the inlet 22 to the outlet 23 is preferably 50 m or less, more preferably 40 m or less, and still more preferably 30 m or less, in terms of space saving. At the same time, the transport length is preferably 5 m or more, and more preferably 10 m or more, in terms of securing the time for carrying out drying.

In the housing 21, the directions in which the drying device 51, 52, 53 and 54 are arranged are not limited. For example, the drying device may be arranged such that the composite film 70 is reciprocated between a vicinity of an upper surface and a vicinity of a lower surface of the housing 21, as shown in FIG. 2. Alternatively, the drying device may be arranged, for example, such that the composite film 70 is reciprocated between the vicinity of a left side surface and the vicinity of a right side surface of the housing 21.

The drying device 51 includes one heating roll and one hot air blowing device. The heating roll 31 and a hot air blowing device 41 included in the drying device 51 are disposed, for example, at positions facing each other with the composite film 70 interposed therebetween. A relationship between the positions of the heating roll 31 and the hot air blowing device 41 is not limited to the positions facing each other with the composite film 70 interposed therebetween, as long as the heating roll 31 and the hot air blowing device 41 are disposed such that composite film 70 in contact with the heating roll 31 is exposed to hot air blown by the hot air blowing device 41.

The drying device 51 may further include another heat-generating device (such as a far-infrared ray irradiation device) for applying heat to the composite film 70, in addition to the heating roll 31 and the hot air blowing device 41.

The embodiments of the drying device 52 to 54, the heating rolls 32 to 34, and hot air blowing device 42 to 44 are the same as the embodiments of the drying device 51, the heating roll 31, and the hot air blowing device 41, respectively.

Although FIG. 2 shows an example of the drying apparatus including four drying device, the number of the drying device is not limited thereto, and can be selected from one or two or more. Further, FIG. 2 shows an exemplary embodiment in which one drying device includes: one contact type heating device; and one hot air blowing device corresponding thereto, while one drying device may include one contact type heating device and two or more hot air blowing device corresponding thereto.

The heating rolls 31 to 34 preferably have an outer diameter of from 10 cm to 200 cm, for example. A width of the heating rolls 31 to 34 is preferably selected depending on a width of the composite film to be manufactured, and the width is, for example, from 10 cm to 300 cm.

Examples of materials for the outer circumferential surfaces of the heating rolls 31 to 34 include stainless steels, metal plating, ceramics, silicone rubbers, and fluororesins. In terms of preventing the composite film from adhering to the heating rolls 31 to 34, the outer circumferential surface of each of the heating rolls 31 to 34 preferably contains a fluororesin. Examples of the fluororesin include polytetrafluoroethylenes (PTFE), perfluoroalkoxy fluororesins (PFA), and tetrafluoroethylene.hexafluoropropylene copolymers (FEP).

A temperature of the outer circumferential surface of each of the heating rolls 31 to 34 is preferably 105° C. or lower, more preferably 100° C. or lower, and still more preferably 95° C. or lower, in terms of preventing the occurrence of shrinkage, deformation and/or wrinkles in the composite film 70. At the same time, the temperature is preferably 65° C. or higher, in terms of drying the composite film 70.

It is preferable that the temperature of the outer circumferential surface of each of the heating rolls 31 to 34 can be controlled independently. The temperatures of the outer circumferential surfaces of the heating rolls 31 to 34 may all be the same, or a part of the temperatures may be the same, or the temperatures may be different from each other.

The heating rolls 31 to 34 are preferably divided into a plurality of groups having different temperatures of the outer circumferential surfaces, in terms of preventing the occurrence of shrinkage, deformation and/or wrinkles in the composite film 70. Examples of dividing the heating rolls into groups, based on whether the temperatures of the outer circumferential surfaces thereof are the same as or different from each other, include the following (i) to (iii). In the following description, T31, T32, T33, and T34 refer respectively to the temperature of the outer circumferential surface of the heating roll 31, the temperature of the outer circumferential surface of the heating roll 32, the temperature of the outer circumferential surface of the heating roll 33, and the temperature of the outer circumferential surface of the heating roll 34.

(i) The heating roll 31 is defined as a first group, the heating rolls 32 and 33 are defined as a second group, and the heating roll 34 is defined as a third group. The temperature of the outer circumferential surface of the heating roll 32 is the same as the temperature of the outer circumferential surface of the heating roll 33.

In the case of the above (i), it is preferable that the temperature of the outer circumferential surfaces of the rolls in the second group is higher than the temperature of the outer circumferential surface of the roll in the first group, and that the temperature of the outer circumferential surface of the roll in the third group is lower than the temperature of the outer circumferential surfaces of the rolls in the second group. In other words, it is preferable that a relation: T31<T32=T33>T34 is satisfied. The temperature of the outer circumferential surface of the roll in the first group may be the same as or different from the temperature of the outer circumferential surface of the roll in the third group, and in a case in which these temperatures are different, it is preferable that the temperature of the outer circumferential surface of the roll in the third group is higher than the temperature of the outer circumferential surface of the roll in the first group.

(ii) The heating rolls 31 and 32 are defined as the first group, and the heating rolls 33 and 34 are defined as the second group. The temperature of the outer circumferential surface of the heating roll 31 and the temperature of the outer circumferential surface of the heating roll 32 are the same. The temperature of the outer circumferential surface of the heating roll 33 and the temperature of the outer circumferential surface of the heating roll 34 are the same.

In the case of the above (ii), it is preferable that the temperature of the outer circumferential surfaces of the rolls in the second group is higher than the temperature of the outer circumferential surfaces of the rolls in the first group. In other words, it is preferable that the relation: T31=T32<T33=T34 is satisfied.

(iii) The heating roll 31 is defined as the first group, the heating roll 32 is defined as the second group, the heating roll 33 is defined as the third group, and the heating roll 34 is defined as a fourth group.

In the case of the above (iii), it is preferable that, the temperature of the outer circumferential surface of the roll in the second group is higher than the temperature of the outer circumferential surface of the roll in the first group, the temperature of the outer circumferential surface of the roll in the third group is higher than the temperature of the outer circumferential surface of the roll in the second group, and the temperature of the outer circumferential surface of the roll in the fourth group is lower than temperature of the outer circumferential surface of the roll in the third group. In other words, it is preferable that the relation: T31<T32<T33>T34 is satisfied. The temperature of the outer circumferential surface of the roll in the first group may be the same as or different from the temperature of the outer circumferential surface of the roll in the fourth group, and in a case in which these temperatures are different, it is preferable that the temperature of the outer circumferential surface of the roll in the fourth group is higher than the temperature of the outer circumferential surface of the roll in the first group. The temperature of the outer circumferential surface of the roll in the second group may be the same as or different from the temperature of the outer circumferential surface of the roll in the fourth group, and in a case in which these temperatures are different, it is preferable that the temperature of the outer circumferential surface of the roll in the fourth group is higher than the temperature of the outer circumferential surface of the roll in the second group.

In any of the above described (i) to (iii), the first group is located at most upstream side in the transport direction of the composite film, and the second group is located directly downstream of the first group, and it is preferable that the temperature of the outer circumferential surface of each heating roll constituting the second group is higher than the temperature of the outer circumferential surface of each heating roll constituting the first group.

Although examples in which four heating rolls are included in the drying apparatus are described above, the number of the heating rolls included therein is not limited thereto. The number of the heating rolls included in each of the groups in the above described (i) to (iii) may be increased or decreased, depending on a total number of the heating rolls included in the drying apparatus.

A total contact length of the heating rolls 31 to 34 with the composite film 70 is preferably 30 m or less, more preferably 20 m or less, and still more preferably 10 m or less, in terms of preventing the occurrence of shrinkage, deformation and/or wrinkles in the composite film 70, and in terms of preventing the peeling of the porous layer. At the same time, the total contact length is preferably 1 m or more, and more preferably 3 m or more, in terms of the drying efficiency. The total contact length is preferably within the above described range, regardless of the number of the heating rolls included in the drying apparatus.

The heating rolls 31 to 34 may be drive rolls which are rotated by a motor, or driven rolls which are rotated as the composite film 70 is transported.

In a case in which the heating rolls 31 to 34 are the drive rolls, it is preferable that a rotational velocity of each of the rolls can be controlled independently. The rotational velocity of each of the heating rolls 31 to 34 is preferably adjusted within the range of +5% or less with respect to the rotational velocity of the heating roll 31, in terms of preventing the occurrence of shrinkage, deformation and/or wrinkles in the composite film 70, and in terms of preventing the peeling of the porous layer. The rotational velocity of each of the heating rolls 31 to 34 may be adjusted, for example, as the following (a) or (b). All of the rotational velocities of the heating rolls 31 to 34 may of course be the same.

(a) The rotational velocity of the heating roll 32 is adjusted to 101%, the rotational velocity of the heating roll 33 is adjusted to 102%, and the rotational velocity of the heating roll 34 is adjusted to 103%, with respect to the rotational velocity of the heating roll 31.

(b) The rotational velocity of the heating roll 32 is adjusted to 101%, the rotational velocity of the heating roll 33 is adjusted to 101%, and the rotational velocity of the heating roll 34 is adjusted to 100%, with respect to the rotational velocity of the heating roll 31.

Next, the hot air blowing device 41 to 44 will be described. Each of the hot air blowing device 41 to 44 includes, for example: a casing having an air intake port for taking in air and an air blowing port(s) for blowing out hot air; and an electric heater, a steam heater or a heat-medium heater, and a fan for blowing air, both disposed inside the casing. The casing has, for example, an arc-shaped curved surface facing the heating roll, and one or a plurality of air blowing ports are provided in the curved surface. The casing is made of, for example, a metal.

In each of the hot air blowing device 41 to 44, warm air including hot air blown out from the air blowing port(s) is preferably taken up by the air intake port, and subjected to temperature adjustment and dew point adjustment, so that the air can be used cyclically.

Examples of the air blowing port provided in the hot air blowing device 41 to 44 include the exemplary embodiments shown in FIG. 3A and FIG. 3B. FIG. 3A and FIG. 3B are schematic diagrams each showing an example of air blowing ports provided in the hot air blowing device 41. In each of FIG. 3A and FIG. 3B, air blowing ports 41b are provided in a surface of a casing 41a on a side facing the heating roll 31. Each of the air blowing ports 41b shown in FIG. 3A has an opening in the shape of a circle, and a plurality of the air blowing ports 41b are arranged periodically in the form of a lattice. Each of the air blowing ports 41b shown in FIG. 3B has an opening in the shape of a long rectangle extending in the direction orthogonal to the transport direction of the composite film 70, and a plurality of the air blowing ports 41b are arranged in the transport direction of the composite film 70 at predetermined intervals.

A distance between the opening of each of the air blowing ports 41b and the heating roll is, for example, from 2 cm to 15 cm, and preferably from 5 cm to 10 cm.

An air blowing direction of hot air blown from the air blowing ports 41b is preferably adjusted such that the distance the blown hot air travels from the opening of each air blowing port 41b to the composite film 70 is the shortest. In other words, the air blowing direction is adjusted such that the blown hot air travels the shortest distance between the opening and the heating roll.

A temperature of hot air blown from each of the hot air blowing device 41 to 44 at the air blowing ports thereof is preferably 105° C. or lower, more preferably 100° C. or lower, and still more preferably 95° C. or lower, in terms of preventing the occurrence of shrinkage, deformation and/or wrinkles in the composite film 70, and in terms of preventing the peeling of the porous layer. At the same time, the temperature is preferably 65° C. or higher, in terms of drying the composite film 70.

A wind velocity of hot air blown from each of the hot air blowing device 41 to 44 at the air blowing ports thereof is preferably 30 m/sec or less, and more preferably 25 m/sec or less, in terms of preventing the occurrence of shrinkage, deformation and/or wrinkles in the composite film 70, and in terms of preventing the peeling of the porous layer. At the same time, the wind velocity is preferably 5 m/sec or more, and more preferably 10 m/sec or more, in terms of the drying efficiency.

The temperatures of hot air blown from the respective hot air blowing device 41 to 44 at the air blowing ports thereof may all be the same, or a part of the temperatures may be the same, or the temperatures may be different from each other. The wind velocities of hot air blown from the respective hot air blowing device 41 to 44 at the air blowing ports thereof may all be the same, or a part of the wind velocities may be the same, or the wind velocities may be different from each other.

In addition, one or a plurality of heating rolls may further be provided immediately downstream of the drying apparatus 10, and the composite film 70 discharged from the drying apparatus 10 may be brought into contact with the above described heating roll(s), to further dry the composite film 70.

One or a plurality of heating rolls may be provided immediately downstream of the drying apparatus 10, for the purpose of subjecting the composite film 70 to thermal relaxation. A temperature of an outer circumferential surface of each heating roll provided for the above described purposes is preferably from 60° C. to 130° C.

Moreover, a pair of upper and lower nip rolls, or a plurality of pairs thereof, for sandwiching the composite film 70 therebetween to remove water therefrom, and/or one or a plurality of air nozzles for blowing wind to the composite film 70 to blow water away therefrom, may be provided immediately upstream of the drying apparatus 10.

The manufacturing method according to the present disclosure may employ the following embodiments.
As a part of the coating liquid preparation step, the solvent for preparing the coating liquid is subjected to a treatment in which the solvent is passed through a filter before being mixed with a resin, in order to remove foreign substances therefrom. The filter to be used in this treatment has a retainable particle diameter of, for example, from 0.1 μm to 100 μm.
An agitator is provided in a tank in which the coating liquid preparation step is carried out, and the coating liquid is constantly stirred with the agitator to prevent precipitation of solid components (such as a filler) in the coating liquid.
A piping for transporting the coating liquid from the coating liquid preparation step to the coating step is arranged in a circular system, and the coating liquid is circulated within the piping to prevent aggregation of solid components in the coating liquid. In this case, it is preferable that a temperature of the coating liquid in the piping is controlled to be constant.
A filter is provided in a middle of a piping for transporting the coating liquid from the coating liquid preparation step to the coating step to remove aggregates and or foreign substances in the coating liquid.
A non-pulsating metering pump is provided as a pump for supplying the coating liquid from the aggregate removal step to the coating step.
A static elimination device is provided upstream of the coating step, for destaticizing the surface of the porous substrate.
A housing is provided around a coating means, to maintain clean the environment in which the coating step is carried out, and to control a temperature and humidity of the atmosphere in the coating step.
A sensor for detecting an amount of the coating liquid coated is provided downstream of the coating means, to correct the coated amount in the coating step.

The porous substrate and the porous layer included in the composite film will now be described in detail.

[Porous Substrate]

The porous substrate refers to a substrate which includes pores or cavities in the interior thereof. Examples of such a substrate include: a microporous film; a porous sheet composed of a fibrous product such as a nonwoven fabric or a paper; and a composite porous sheet obtained by layering one or more other porous layers on the microporous film or the porous sheet as described above. In the present disclosure, a microporous film is preferred, in terms of obtaining a thinner and stronger composite film. The microporous film refers to a film which includes a number of micropores in the interior thereof, and has a structure in which these micropores are connected, so that a gas or a liquid is able to pass therethrough from one surface to the other surface of the film.

A material as a component of the porous substrate is preferably a material having an electrical insulating property, and may be either an organic material or an inorganic material.

The material as a component of the porous substrate is preferably a thermoplastic resin, in terms of imparting a shutdown function to the porous substrate. The shutdown function refers to a function, in a case in which the composite film is used as a battery separator, in which the component material is melted to clog the pores of the porous substrate, when the temperature of the battery is increased, thereby blocking ion migration and preventing a thermal run away of the battery. The thermoplastic resin is suitably a thermoplastic resin having a melting temperature of less than 200° C., and particularly preferably a polyolefin.

The porous substrate is preferably a microporous film containing a polyolefin (hereinafter, also referred to as “polyolefin microporous film). Examples of the polyolefin microporous film include polyolefin microporous films used in conventional battery separators. Among these, one having favorable mechanical properties and substance permeability can be preferably selected.

The polyolefin microporous film preferably contains one or both of polyethylene in terms of exhibiting the shutdown function. A content of polyethylene in the polyolefin microporous film is preferably 95% by mass or more with respect to a total mass of the polyolefin microporous film.

The polyolefin microporous film is preferably a polyolefin microporous film containing polyethylene and polypropylene, since such a film has a heat resistance sufficient for preventing the film from easily rupturing when exposed to a high temperature. Examples of the polyolefin microporous film as described above include a microporous film in which polyethylene and polypropylene coexist within one layer. The microporous film as described above preferably contains 95% by mass or more of polyethylene and 5% by mass or less of polypropylene, in terms of obtaining both the shutdown function and the heat resistance in a balanced manner. Further, in terms of obtaining both the shutdown function and the heat resistance in a balanced manner, the microporous film is preferably a polyolefin microporous film having a laminated structure composed of two or more layers, in which at least one layer contains polyethylene and at least one layer contains polypropylene.

The polyolefin included in the polyolefin microporous film suitably has a weight-average molecular weight of from 100,000 to 5,000,000. When the polyolefin has a weight-average molecular weight of greater than 100,000, sufficient mechanical properties can be imparted to the microporous film. When the polyolefin has a weight-average molecular weight of less than 5,000,000, the microporous film has a favorable shut down property, and the film formation of the microporous film can be carried out easily.

Examples of manufacturing the polyolefin microporous film include: a method in which a melted polyolefin resin is extruded from a T-die to be formed into a sheet. The resultant is subjected to a crystallization treatment, followed by stretching, and then further subjected to a heat treatment, thereby obtaining a microporous film; and a method in which a polyolefin resin melted along with a plasticizer, such as liquid paraffin, is extruded from a T-die, the resultant is cooled to be formed into a sheet, stretching the resulting sheet, the plasticizer is extracted therefrom, and the resultant is subjected to a heat treatment, thereby obtaining a microporous film.

Examples of the porous sheet composed of a fibrous product include porous sheets, such as nonwoven fabrics and papers, composed of fibrous products such as: polyesters such as polyethylene terephthalate; polyolefins such as polyethylene and polypropylene; heat resistant resins such as aromatic polyamides, polyimides, polyethersulfones, polysulfones, polyether ketones, and polyetherimides; and celluloses. The heat resistant resin refers to a resin having a melting temperature of 200° C. or higher, or a resin which does not have a melting temperature and has a decomposition temperature of 200° C. or higher.

Examples of the composite porous sheet include one that has a structure in which a functional layer(s) is/are layered on a porous sheet composed of a microporous film or a fibrous product. Such a composite porous sheet is preferred, because the functional layer(s) included therein allow(s) for imparting an additional function(s). In terms of imparting heat resistance, for example, a porous layer composed of a heat resistant resin, or a porous layer composed of a heat resistant resin and an inorganic filler can be used as the functional layer. The heat resistant resin may be, for example, one kind or two or more kinds of heat resistant resins selected from aromatic polyamides, polyimides, polyethersulfones, polysulfones, polyether ketones or polyetherimides. Examples of the inorganic filler include a metal oxide such as an alumina and a metal hydroxide such as magnesium hydroxide. The composite porous sheet having the above structure may be formed, for example, by: a method in which a functional layer is coated on a microporous film or a porous sheet; a method in which a microporous film or a porous sheet and a functional layer are bonded with an adhesive agent; and a method in which a microporous film or a porous sheet and a functional layer are bonded by thermocompression bonding.

The porous substrate preferably has a width of from 0.1 m to 3.0 m, in terms of compatibility with the manufacturing method according to the present disclosure.

The porous substrate preferably has a thickness of from 5 μm to 50 μm.

The porous substrate preferably exhibits a heat shrinkage ratio in the MD direction of 10% or less, and more preferably 5% or less, and preferably has a heat shrinkage ratio in the TD direction of 5% or less, and more preferably 3% or less, when measured after being left to stand at a temperature of 105° C. for 30 minutes.

The porous substrate preferably has an elongation at break in the MD direction of 10% or more, and more preferably 20% or more, and preferably has an elongation at break in the TD direction of 10% or more, and more preferably 20% or more, in terms of the mechanical strength. The elongation at break of the porous substrate is obtained by carrying out a tensile test using a tensile tester, in an atmosphere at a temperature of 20° C. and at a tensile speed of 100 m m/min.

The porous substrate preferably has a Gurley value (JIS P8117 (2009)) of 50 sec/100 cc to 800 sec/100 cc, in terms of the mechanical strength and the substance permeability.

The porous substrate preferably has a porosity of 20% to 60%, in terms of the mechanical strength, handling property, and the substance permeability.

The porous substrate preferably has an average pore diameter of from 20 nm to 100 nm, in terms of the substance permeability. The average pore diameter as used herein refers to a value measured using a palm porometer, in accordance with ASTM E1294-89.

[Porous Layer]

The porous layer refers to a layer which includes a number of micropores in the interior thereof, and has a structure in which these micropores are connected, so that a gas or a liquid is able to pass therethrough from one surface to the other surface of the film.

In a case in which the composite film is used as a battery separator, the porous layer is preferably an adhesive porous layer capable of adhering to an electrode. It is more preferable that the adhesive porous layer is provided on both surfaces of the porous substrate, rather than being provided on only one surface of the porous substrate.

The porous layer is formed by coating a coating liquid containing a resin. Accordingly, the porous layer contains a resin. The porous layer is preferably formed by coating a coating liquid containing a resin and a filler in terms of porosifying the porous layer. Therefore, the porous layer preferably contains a resin and a filler. The filler may be either an inorganic filler or an organic filler. The filler is preferably inorganic particles, in terms of porosifying the porous layer and of heat resistance. A description will now be given below regarding the porous layer, and the components, such as a resin, contained in the coating liquid and the porous layer.

[Resin]

A type of the resin to be contained in the porous layer is not limited. The resin to be contained in the porous layer is preferably a resin (so-called binder resin) having a function to bind particles of a filler. In terms of compatibility to the wet process, the resin to be contained in the porous layer is preferably a hydrophobic resin, in terms of production compatibility. In a case in which the composite film is used as a battery separator, the resin to be contained in the porous layer is preferably a resin which is stable in an electrolyte solution, which is electrochemically stable, which has a function of binding inorganic particles, and which is capable of adhering to an electrode. The porous layer may contain one kind of resin, or two or more kinds of resins.

Examples of the resin to be contained in the porous layer is preferably polyvinylidene fluoride, a polyvinylidene fluoride copolymer, a styrene-butadiene copolymer, a homopolymer or a copolymer of a vinyl nitrile such as acrylonitrile or methacrylonitrile, or a polyether such as polyethylene oxide or polypropylene oxide. Of these, polyvinylidene fluoride and a polyvinylidene fluoride copolymer (referred to as a polyvinylidene fluoride resin,) are preferred.

Examples of the polyvinylidene fluoride resin include a homopolymer of vinylidene fluoride (namely, polyvinylidene fluoride), a copolymer of vinylidene fluoride and another monomer copolymerizable with vinylidene fluoride (namely, a polyvinylidene fluoride copolymer), and any mixture of these resins. Examples of the monomer copolymerizable with vinylidene fluoride include tetrafluoroethylene, hexafluoropropylene, trifluoroethylene, trichloroethylene, and vinyl fluoride. One kind or two or more kinds of these monomers can be used. The polyvinylidene fluoride resin can be obtained by emulsion polymerization or suspension polymerization.

The resin to be contained in the porous layer is preferably a heat resistant resin (a resin having a melting temperature of 200° C. or higher, or a resin which does not have a melting temperature and has a decomposition temperature of 200° C. or higher), in terms of heat resistance. Examples of the heat resistant resin include polyamides (nylons), wholly aromatic polyamides (aramids), polyimides, polyamideimides, polysulfones, polyketones, polyether ketones, polyether sulfones, polyetherimides, celluloses, and any mixture of these resins. Among these, a wholly aromatic polyamide is preferred, in terms of ease of forming a porous structure, ability to bind to inorganic particles, and oxidation resistance. Among the wholly aromatic polyamides, a meta-type wholly aromatic polyamide is preferred, and polymetaphenylene isophthalamide is particularly preferred, in terms of ease of shaping.

[Inorganic Filler]

The porous layer preferably contains inorganic particles as the filler. The inorganic particle to be contained in the porous layer is preferably particles which are stable in an electrolyte solution, and at the same time, electrochemically stable. The porous layer may contain one kind of inorganic particles, or two or more kinds thereof.

Examples of the inorganic particles to be contained in the porous layer include: metal hydroxides such as aluminum hydroxide, magnesium hydroxide, calcium hydroxide, chromium hydroxide, zirconium hydroxide, cerium hydroxide, nickel hydroxide, and boron hydroxide; metal oxides such as silica, alumina, zirconia, and magnesium oxide; carbonates such as calcium carbonate and magnesium carbonate; sulfates such as barium sulfate and calcium sulfate; and clay minerals such as calcium silicate and talc. Among these, a metal hydroxide and a metal oxide are preferred, in terms of imparting flame retardancy or of a destaticizing effect. The inorganic particles may be particles which have been surface modified by a silane coupling agent or the like.

The inorganic particles may have an arbitrary shape, and may be in the shape of any of spheres, ellipsoids, plates, and needles, or may be amorphous. It is preferable that the primary particles of the inorganic particles have a volume average particle diameter of from 0.01 μm to 10 μm, and more preferably from 0.1 μm to 10 μm, in terms of shaping property of the porous layer, the substance permeability of the composite film, and the slippage of the composite film.

In a case in which the porous layer contains inorganic particles, a ratio of the inorganic particles with respect to a total amount of the resin and the inorganic particles is, for example, from 30% by volume to 90% by volume.

The porous layer may contain an organic filler or another component. Examples of the organic filler include: particles composed of crosslinked polymers such as crosslinked poly(meth)acrylic acids, crosslinked poly(meth) acid esters, crosslinked polysilicones, crosslinked polystyrenes, crosslinked polydivinylbenzenes, crosslinked products of styrene-divinylbenzene copolymers, polyimides, melamine resins, phenol resins, and benzoguanamine-formaldehyde condensation products; and particles composed of heat resistant resins such as polysulfones, polyacrylonitriles, aramids, polyacetals, and thermoplastic polyimides.

The porous layer preferably has a thickness, on one surface of the porous substrate, of from 0.5 μm to 5 μm, in terms of the mechanical strength.

The porous layer preferably has a porosity of from 30% to 80%, in terms of the mechanical strength, the handling property, and the substance permeability.

The porous layer preferably has a pore diameter of from 20 nm to 100 nm, in terms of the substance permeability. An average pore diameter of the porous layer herein refers to a value measured using a palm porometer, in accordance with ASTM E1294-89.

[Property of Composite Film]

A thickness of the composite film may be, for example, from 5 μm to 100 μm. When used as a battery separator, the composite film has a thickness of from 5 μm to 50 μm, for example.

The composite film preferably has a Gurley value (JIS P8117 (2009)) of from 50 sec/100 cc to 800 sec/100 cc, in terms of the mechanical strength and the substance permeability.

The composite film preferably has a porosity of from 30% to 60%, in terms of the mechanical strength, the handling property, and the substance permeability.

A porosity of the composite film is determined by the following equation. A porosity of the porous substrate and a porosity of the porous layer are also determined in the same manner.

Porosity (%)={1−(Wa/da+Wb/db+Wc/dc+ . . . +Wn/dn)/t}×100

In the equation, Wa, Wb, Wc, . . . , Wn are the weights (g/cm²) of constituent materials a, b, c, . . . , n respectively; da, db, dc, . . . , dn are the true densities (g/cm³) of the constituent materials a, b, c, . . . , n respectively; and t is the film thickness (cm) of a layer of interest.

[Applications of Composite Film]

The composite film can be used, for example, as a battery separator, a film for a capacitor, a gas filter, a liquid filter, or the like. In particular, the composite film in the present disclosure is particularly suitably used as a nonaqueous secondary battery separator.

### EXAMPLES

Hereinafter, the present invention is described in further detail with reference to Examples. The material, amount of use, proportion, procedure, or the like described below can be appropriately modified without deviating from the spirit of the present invention. Therefore, the scope of the present invention should not be construed to be limited by the following specific examples.

<Method for Measurement of Physical Property>

The following measurement methods were applied in Examples and Comparative Examples.

[Film Thickness]

The film thickness (μm) of the porous substrate was obtained by measuring the thickness at arbitrary 20 points within an area of 10 cm×30 cm in the porous substrate, using a contact type thickness meter (LITEMATIC; manufactured by Mitutoyo Corporation), and by calculating an average of the measured values. The measurement was carried out using a measuring terminal in the form of a cylinder having a diameter of 5 mm, with the load applied during the measurement adjusted to 7 g.

[Heat Shrinkage Ratio at 105° C.]

Three samples each having a size of 19 cm in the MD direction×6 cm in the TD direction were cut out from the porous substrate. The samples were hung in an oven which maintains its internal temperature to be 105° C., each sample being held by a clip at one end thereof, such that the MD direction of the sample corresponds to the direction of gravity. The samples were then left to stand in the oven for 30 minutes in a tensionless state. The lengths of each sample in the MD direction and in the TD direction were measured, before and after the heat treatment for 30 minutes. Then the heat shrinkage ratios (%) of each sample in the MD direction and in the TD direction were calculated according to the following equation, and the averages of the three samples were then calculated.

Heat shrinkage ratio (%)=(length before the heat treatment-length after the heat treatment)/length before the heat treatment×100

[Drying State of Composite Film]

A moisture content of the composite film was measured by an infrared moisture meter, and the drying state of the composite film was classified based on the following standards.

A: The moisture content is less than 1%.
B: The moisture content is 1% or more but less than 3%.
C: The moisture content is 3% or more but less than 5%.
D: The moisture content is 5% or more.

[Shrinkage of Composite Film]

The width of the composite film was measured before and after the drying step, and the shrinkage ratio (%) of the composite film was then calculated. The composite film was classified based on the following standards.

A: The shrinkage ratio is less than 36%.

B: The shrinkage ratio is 3% or more but less than 5%.

C: The shrinkage ratio is 5% or more.

[Wrinkles of Composite Film]

Immediately after the water washing step and immediately after the drying step, an appearance of the composite film was visually observed, and the occurrence of wrinkles was classified based on the following standards.

A: No wrinkles were observed.
B: Slight wrinkles were observed immediately after the water washing step. The wrinkles disappear in the drying step.
C: Winkles were observed immediately after the water washing step. The wrinkles do not disappear in the drying step.

[Peeling of Porous Layer]

The composite film was tested by a defect tester, and the presence of a bright defect (a portion which is brighter than the surrounding portion) and a dark defect (a portion which is darker than the surrounding portion) was detected. A degree of peeling of the porous layer was classified according to the following standards, based on the size (maximum diameter) of the defects, and the number of the defects within an area of 100 m² in the composite film. A portion at which the porous layer is peeled is detected as the bright defect. A portion at which the peeled porous layer adhered to the surface of the composite film is detected as the dark defect.

A: The number of defects having a size of 500 μm or less is less than 10, and the number of defects having a size of 5 mm or less is less than one.

B: The number of defects having a size of 500 μm or less is 10 or more but less than 50, and the number of defects having a size of 5 mm or less is less than one.

C: The number of defects having a size of 500 μm or less is 50 or more, and the number of defects having a size of 5 mm or less is one or more.

<Production of Composite Film>

### Example 1

### —Drying Apparatus—

As a drying apparatus for carrying out the drying step, a drying apparatus as shown in FIG. 2 was prepared. A formation of the drying apparatus is as follows.

The drying apparatus includes a metal housing having an inlet and an outlet and four drying device disposed in the metal housing. Each of the four drying device includes one heating roll and one hot air blowing device, and the heating roll and the hot air blowing device are disposed so as to face each other with the composite film interposed therebetween. An outer circumferential surface of each of four heating rolls contains polytetrafluoroethylene.

Each of the four hot air blowing device includes: a casing having an air intake port for taking in air and air blowing ports for blowing out hot air; and an electric heater and a fan for blowing air, both disposed inside the casing. The casing has an arc-shaped curved surface facing the heating roll, and the air blowing ports are provided in the curved surface. The air blowing ports provided in the hot air blowing device are arranged as shown in the exemplary embodiment shown in FIG. 3A.

A temperature of the outer circumferential surfaces of the heating rolls, a temperature and a wind velocity of hot air blown from the hot air blowing device at the air blowing ports thereof, a total contact length of the heating rolls with the composite film, and a transport length and a transport speed of the composite film in the drying apparatus, are as shown in Table 1.

—Porous Substrate—

A polyethylene microporous film (PE film) having a long length and a width of 1 m was prepared as the porous substrate. Physical properties of the polyethylene microporous film are shown in Table 1.

—Coating Liquid Preparation Step—

Polymetaphenylene isophthalamide (PMIA) was dissolved in a solvent (a mixed solvent of dimethylacetamide and tripropylene glycol), and magnesium hydroxide was dispersed in the resultant, to obtain a coating liquid having a viscosity of 3,000 cP (centipoise). The coating liquid was adjusted to a composition (in mass ratio) of polymetaphenylene isophthalamide:magnesium hydroxide:dimethylacetamide:tripropylene glycol=4:16:48:32.

—Coating Step and Solidification Step—

The coating liquid (liquid temperature: 20° C.) obtained above was coated on both surfaces of the porous substrate in equal amounts, to form coating layers on both surfaces of the porous substrate. The porous substrate on which the coating layers had been formed was transported to a solidification tank, and immersed in a solidifying liquid (water:dimethylacetamide:tripropylene glycol=40:36:24 [mass ratio], liquid temperature: 30° C.) to solidify the resin contained in the coating layers, thereby obtaining a composite film.

—Water Washing Step and Drying Step—

The composite film was transported to a water bath controlled to a temperature of 30° C. and washed with water. After the water washing, the composite film was made to pass through a drying apparatus equipped with heating rolls to carry out drying.

The respective steps described above were carried out continuously, to obtain a composite film including a polyethylene microporous film and a porous layer formed on one surface of the polyethylene microporous film. The quality of the thus obtained composite film was evaluated, and the results are shown in Table 1. Data and the evaluation results of composite films obtained in other Examples and Comparative Examples are also shown in Table 1.

### Comparative Examples 1 to 4

A composite film was prepared in the same manner as in Example 1, except that the conditions of the drying were changed as shown in Table 1.

### Examples 2 to 7

A composite film was prepared in the same manner as in Example 1, except that the conditions of the drying were changed as shown in Table 1.

### Examples 8 to 10

A composite film was prepared in the same manner as in Example 1, except that the porous substrate was changed to a polyethylene microporous film (PE film), and the conditions of the drying were changed as shown in Table 1.

### Example 11

A composite film was prepared in the same manner as in Example 1, except that in the coating liquid preparation, polymetaphenylene isophthalamide was changed to polyvinylidene fluoride (PVDF).

### Example 12

A composite film was prepared in the same manner as in Example 1, except that the porous substrate was changed to a polyethylene terephthalate nonwoven fabric (PET nonwoven fabric).

TABLE 1

| | | | | | | | Drying step | | | | | | | | | |
|---|---|---|---|---|---|---|---|---|---|---|---|---|---|---|---|---|
| | Porous substrate | | | | | | Temp- | | | Total | | | | | | |
| | | | Heat | Heat | | | erature | | | contact | | | | | | |
| | | | shrink- | shrink- | | | of | | | length | | | | | | |
| | | | age | age | | | outer | | | of | | | | | | |
| | | | ratio | ratio | | | peri- | | | heating | | | | | | |
| | | | in | in | Coating step | | pheral | | | rolls | | | | | | |
| | | | MD | TD | Resin | Coat- | surfaces | Hot air | | with | | Trans- | | | | |
| | | Film | direc- | direc- | includ- | ed | of | blowing device | | com- | Trans- | port | Composite film | | | |
| | | thick- | tion at | tion at | ed in | sur- | heating | Temp- | Wind | posite | port | speed | Dry- | | | |
| | | ness | 105° | 105° | coating | face | rolls | erature | velocity | film | length | m/ | ing | Shrink- | Wrin- | Peel- |
| | Type | μm | C. % | C. % | liquid | (s) | ° C. | ° C. | m/sec | m | m | min | state | age | kles | ing |
| Com- | PE | 10 | 3 | 1 | PMIA | Both | 70 | Not provided | | 10 | 15 | 40 | D | A | A | C |
| par- | film | | | | | sur- | | | | | | | | | | |
| ative | | | | | | faces | | | | | | | | | | |
| Exam- | | | | | | | | | | | | | | | | |
| ple 1 | | | | | | | | | | | | | | | | |
| Com- | PE | 10 | 3 | 1 | PMIA | Both | 70 | Not provided | | 35 | 50 | 40 | A | A | C | C |
| par- | film | | | | | sur- | | | | | | | | | | |
| ative | | | | | | faces | | | | | | | | | | |
| Exam- | | | | | | | | | | | | | | | | |
| ple 2 | | | | | | | | | | | | | | | | |
| Com- | PE | 10 | 3 | 1 | PMIA | Both | Not | 90 | 15 | (10) | 15 | 40 | D | C | C | C |
| par- | film | | | | | sur- | heated | | | | | | | | | |
| ative | | | | | | faces | | | | | | | | | | |
| Exam- | | | | | | | | | | | | | | | | |
| ple 3 | | | | | | | | | | | | | | | | |
| Com- | PE | 10 | 3 | 1 | PMIA | Both | 90 | 90 | 15 | 10 | 15 | 25 | A | B | C | C |
| par- | film | | | | | sur- | | | | | | | | | | |
| ative | | | | | | faces | | | | | | | | | | |
| Exam- | | | | | | | | | | | | | | | | |
| ple 4 | | | | | | | | | | | | | | | | |
| Exam- | PE | 10 | 3 | 1 | PMIA | Both | 70 | 70 | 15 | 10 | 15 | 40 | A | A | A | A |
| ple 1 | film | | | | | sur- | | | | | | | | | | |
| | | | | | | faces | | | | | | | | | | |
| Exam- | PE | 10 | 3 | 1 | PMIA | Both | 85 | 90 | 15 | 10 | 15 | 70 | B | A | A | A |
| ple 2 | film | | | | | sur- | | | | | | | | | | |
| | | | | | | faces | | | | | | | | | | |
| Exam- | PE | 10 | 3 | 1 | PMIA | Both | 90 | 90 | 15 | 10 | 15 | 70 | A | B | B | A |
| ple 3 | film | | | | | sur- | | | | | | | | | | |
| | | | | | | faces | | | | | | | | | | |
| Exam- | PE | 10 | 3 | 1 | PMIA | Both | 85 | 90 | 5 | 10 | 15 | 70 | C | A | A | B |
| ple 4 | film | | | | | sur- | | | | | | | | | | |
| | | | | | | faces | | | | | | | | | | |
| Exam- | PE | 10 | 3 | 1 | PMIA | Both | 85 | 90 | 30 | 10 | 15 | 70 | A | B. | B | A |
| ple 5 | film | | | | | sur- | | | | | | | | | | |
| | | | | | | faces | | | | | | | | | | |
| Exam- | PE | 10 | 3 | 1 | PMIA | Both | 85 | 90 | 15 | 5 | 8 | 40 | C | A | B | B |
| ple 6 | film | | | | | sur- | | | | | | | | | | |
| | | | | | | faces | | | | | | | | | | |
| Exam- | PE | 10 | 3 | 1 | PMIA | Both | 85 | 90 | 15 | 8 | 12 | 40 | B | A | B | A |
| ple 7 | film | | | | | sur- | | | | | | | | | | |
| | | | | | | faces | | | | | | | | | | |
| Exam- | PE | 12 | 6 | 3 | PMIA | Both | 70 | 70 | 15 | 10 | 15 | 70 | C | A | A | B |
| ple 8 | film | | | | | sur- | | | | | | | | | | |
| | | | | | | faces | | | | | | | | | | |
| Exam- | PE | 12 | 6 | 3 | PMIA | Both | 85 | 90 | 15 | 10 | 15 | 70 | B | A | A | A |
| ple 9 | film | | | | | sur- | | | | | | | | | | |
| | | | | | | faces | | | | | | | | | | |
| Exam- | PE | 12 | 6 | 3 | PMIA | Both | 90 | 90 | 15 | 10 | 15 | 70 | A | B | B | A |
| ple 10 | film | | | | | sur- | | | | | | | | | | |
| | | | | | | faces | | | | | | | | | | |
| Exam- | PE | 10 | 3 | 1 | PVDF | Both | 70 | 70 | 15 | 10 | 15 | 40 | A | A | A | A |
| ple 11 | film | | | | | sur- | | | | | | | | | | |
| | | | | | | faces | | | | | | | | | | |
| Exam- | PET | 20 | 1.5 | 0 | PMIA | Both | 70 | 70 | 15 | 10 | 15 | 40 | A | A | A | A |
| ple 12 | non- | | | | | sur- | | | | | | | | | | |
| | woven | | | | | faces | | | | | | | | | | |
| | fabric | | | | | | | | | | | | | | | |

The disclosure of Japanese Patent Application No. 2015-067607, filed on Mar. 27, 2015, is incorporated herein by reference in its entirety.

All publications, patent applications, and technical standards mentioned in the present specification are incorporated herein by reference to the same extent as if such individual publication, patent application, or technical standard was specifically and individually indicated to be incorporated by reference.

1. A method of manufacturing a composite film, the method comprising:
a coating step comprising coating a coating liquid containing a resin on one surface or both surfaces of a porous substrate to form a coating layer;
a solidification step comprising solidifying the resin by bringing the coating layer into contact with a solidifying liquid to obtain a composite film comprising the porous substrate and a porous layer that is formed on one surface or both surfaces of the porous substrate and that comprises the resin;
a water washing step comprising washing the composite film with water; and
a drying step comprising drying by removing water from the composite film while transporting the composite film at a transport speed of 30 m/min or more using a drying apparatus comprising a drying device including a contact type heating device and a hot air blowing device, wherein the composite film is brought into contact with a contact type heating device as well as exposed to hot air blown from a hot air blowing device, to remove water from the composite film being performed by bringing.

2. The method of manufacturing a composite film according to claim 1, wherein the porous substrate would exhibit a heat shrinkage ratio in a machine direction of 10% or less and a heat shrinkage ratio in a width direction of 5% or less, when the porous substrate has been left to stand at a temperature of 105° C. for 30 minutes.

3. The method of manufacturing a composite film according to claim 1,
wherein a surface of the contact type heating device which comes into contact with the composite film has a temperature of 105° C. or lower, and
wherein the hot air has a temperature of 105° C. or lower at an air blowing port of the hot air blowing device.

4. The method of manufacturing a composite film according to claim 1, wherein the hot air has a wind velocity of from 5 m/sec to 30 m/sec at an air blowing port of the hot air blowing device.

5. The method of manufacturing a composite film according to claim 1,
wherein the drying apparatus comprises two or more of the drying device;
wherein two or more contact type heating devices included in the drying apparatus are divided into two or more groups based on whether temperatures of surfaces of the contact type heating devices that come into contact with the composite film are the same as or different from each other, the two or more groups including a first group located at most upstream in a transport direction of the composite film and a second group located directly downstream of the first group; and
wherein the temperature of the surface of each of the contact type heating devices forming the second group is higher than the temperature of the surface of each of the contact type heating devices forming the first group.

6. The method of manufacturing a composite film according to claim 1, wherein a total contact length of the contact type heating device(s) with the composite film is 30 m or less.

7. The method of manufacturing a composite film according to claim 1, wherein the drying apparatus comprises a housing having an inlet and an outlet and the drying device is disposed in the housing, and wherein a length of transportation of the composite film from the receiving inlet to the outlet is 50 m or less.

8. The method of manufacturing a composite film according to claim 1, wherein a surface of the contact type heating device which come into contact with the composite film contains a fluororesin.
